(19) United States
(12) Patent Application Publication
(10) Pub. No.: US 2007/0018575 A1
(43) Pub. Date: Jan. 25, 2007

(54) PLASMA DISPLAY PANEL AND METHOD OF MANUFACTURING BARRIER RIB THEREOF

(75) Inventor: Bo Hyun Kim, Suwon-si, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/456,927

(22) Filed: Jul. 12, 2006

(30) Foreign Application Priority Data
Jul. 19, 2005 (KR) 10-2005-0065402

(51) Int. Cl. H01J 17/49

(52) U.S. Cl. 313/582

(57) ABSTRACT

A plasma display panel and a method of manufacturing barrier ribs thereof are disclosed. The plasma display panel includes barrier ribs for dividing a plurality of light emitting cells from one another. Side surfaces of the barrier ribs facing the light emitting cells have a plurality of convexities and at least one concavity formed between the convexities.

This application claims the benefit of the Korean Patent Application No. P2005-0065402, filed on Jul. 19, 2005, which is hereby incorporated by reference as if fully set forth herein.

### BACKGROUND OF THE INVENTION

1. Field of the Invention

The present invention relates to a plasma display panel and a method of manufacturing barrier ribs thereof.

2. Discussion of the Related Art

Generally, plasma display panels are display apparatuses in which ultraviolet rays generated by gas discharge excite phosphors, thus causing the phosphors to generate visible rays.

Conventional plasma display panels include discharge cells arranged in matrix form. Each of the discharge cells, as shown in FIG. 1, includes an upper substrate 100 providing an image display surface and a lower substrate 110 arranged parallel to the upper substrate 100 by interposing barrier ribs 113.

A plurality of pairs of sustain electrodes 101 and 102, an upper dielectric layer 103 and a protective film 104 are formed on the upper substrate 100 in this sequence. Here, each sustain electrode 101 or 102 includes a transparent electrode a and bus electrode b. Also, address electrodes 111 for causing discharge with the pairs of sustain electrodes 101 and 102 and a lower dielectric layer 112 are formed on the lower substrate 110 in this sequence.

Phosphors 114 for generating visible rays having original colors are applied to side surfaces of the barrier ribs 113 over the lower dielectric layer 112.

The phosphors 114 are excited by vacuum ultraviolet rays of short wavelengths generated upon gas discharge, to thereby generate Red, Green and Blue visible rays.

In the conventional plasma display panel having the above described configuration, the barrier ribs thereof basically may be classified into a stripe type and a well type.

In the stripe type, barrier ribs are arranged in line. This has an advantage of a simplified manufacturing process.

However, the stripe type barrier ribs have a problem in that phosphors of each discharge cell can easily penetrate an adjacent discharge cell and be mixed with other phosphors of the adjacent discharge cell, thus causing disadvantageous emission of mixed color light.

As a solution of the above described problem, a well type barrier rib configuration, which is obtained by adding horizontal barrier ribs to the stripe type barrier rib configuration, has been proposed.

In the well type barrier rib configuration, although it prevents mixing of phosphors of adjacent light emitting cells, there still exists a limit to improve brightness and light emission efficiency of the plasma display panel.

### SUMMARY OF THE INVENTION

Accordingly, the present invention is directed to a plasma display panel and a method of manufacturing barrier ribs thereof that substantially obviate one or more problems due to limitations and disadvantages of the related art.

An object of the present invention is to provide a plasma display panel and a method of manufacturing barrier ribs thereof, which can achieve improvement in the brightness and light emission efficiency of the plasma display panel via an improved barrier rib structure.

Another object of the present invention is to provide a plasma display panel and a method of manufacturing barrier ribs thereof, which can achieve an improved barrier rib structure with a simplified manufacturing process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel having barrier ribs dividing a plurality of light emitting cells from one another, comprises: a plurality of convexities formed on side surfaces of the barrier ribs facing the light emitting cells at predetermined regions of the side surfaces; and at least one concavity formed between the convexities.

A boundary between the associated concavity and convexity may be formed perpendicular to the concavity and convexity, or may be inclined.

Each convexity or concavity may have a shape selected from among a flat shape, round shape, horn shape, and the like.

Uppermost and lowermost portions of the side surfaces of the barrier ribs may have a convex shape.

In accordance with a second aspect of the present invention, there is provided a plasma display panel having barrier ribs dividing a plurality of light emitting cells from one another, wherein each barrier rib includes: a plurality of first layers having a predetermined width; and at least one second layer formed between the first layers and having a width smaller than that of the first layers.

The first and second layers may be made of materials having different etching rates from each other, and the first layer may be made of a material having an etching rate lower than that of the second layer.

The first and second layers may have different thicknesses from each other, and the first layer may have a thickness larger than that of the second layer.

A boundary between the first and second layers may be formed perpendicular to side surfaces of the first and second layers, or may be inclined relative to the side surfaces. Uppermost and lowermost layers of the barrier ribs may be formed of the first layers having a width larger than that of the second layer.

In accordance with a third aspect of the present invention, there is provided a method of manufacturing barrier ribs of a plasma display panel for dividing a plurality of light emitting cells from one another, comprising: forming a dielectric layer on a substrate having electrodes; forming a barrier rib paste having a predetermined height by alternately stacking a first paste and second paste on the dielectric layer, the first paste and second paste having different etching rates from each other; and forming the barrier ribs having convexities and concavities at side surfaces thereof by etching predetermined regions of the barrier rib paste.

Here, the formation of the barrier ribs having convexities and concavities at side surfaces thereof comprises: forming a dry film resist on the barrier rib paste; exposing and developing predetermined regions of the dry film resist; forming the barrier ribs to have the convexities and concavities at the side surfaces thereof by etching the barrier rib paste by use of the dry film resist as an etching mask; and removing the residual dry film resist.

In accordance with a fourth aspect of the present invention, there is provided a method of manufacturing barrier ribs of a plasma display panel for dividing a plurality of light emitting cells from one another, comprising: forming a dielectric layer on a substrate having electrodes; forming a barrier rib green sheet having a predetermined height by alternately stacking a first dry film and second dry film on the dielectric layer, the first dry film and second dry film having different etching rates from each other; and forming the barrier ribs having convexities and concavities at side surfaces thereof by etching predetermined regions of the barrier rib green sheet.

Here, the formation of the barrier ribs having convexities and concavities at side surfaces thereof comprises: forming a dry film resist on the barrier rib green sheet; exposing and developing predetermined regions of the dry film resist; forming the barrier ribs to have the convexities and concavities at the side surfaces thereof by etching the barrier rib green sheet by use of the dry film resist as an etching mask; and removing the residual dry film resist.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating the configuration of a conventional plasma display panel;

FIG. 2 is a sectional view illustrating a plasma display panel according to the present invention;

FIGS. 3A to 3F are sectional views illustrating a process of manufacturing barrier ribs of the plasma display panel according to a first embodiment of the present invention; and

FIGS. 4A to 4F are sectional views illustrating a process of manufacturing barrier ribs of the plasma display panel according to a second embodiment of the present invention.

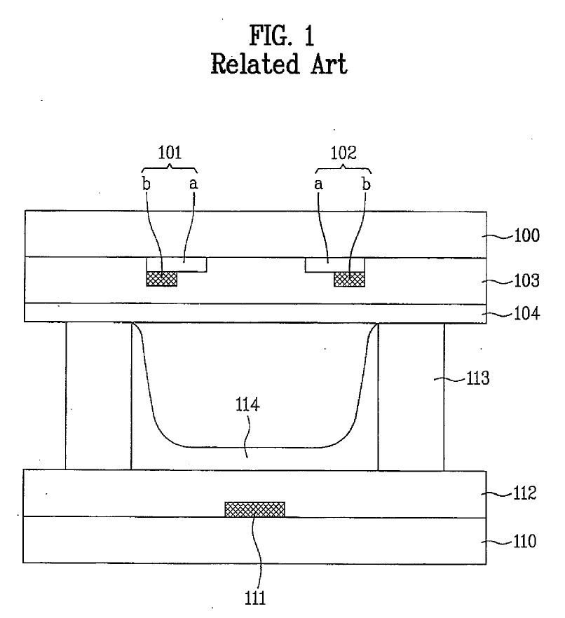

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The technical idea of the present invention is in that side surfaces of each barrier rib facing light emitting cell are configured to have a “convex and concave” shape, to prevent color mixture of phosphors between adjacent light emitting cells while increasing a phosphor application area, thereby achieving improvement in the brightness and discharge efficiency of the plasma display panel.

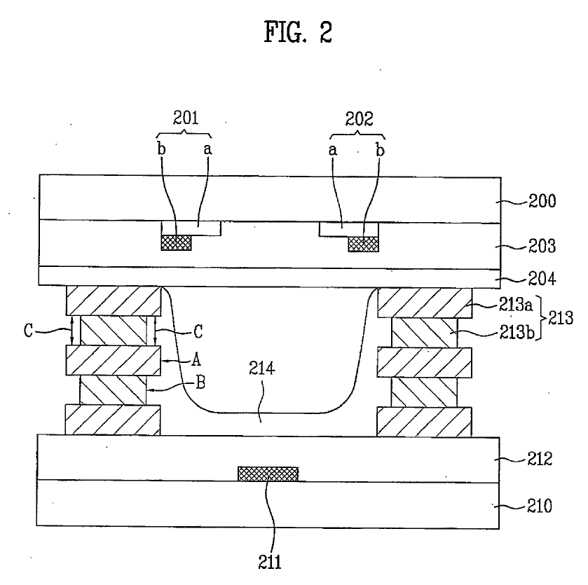

FIG. 2 is a sectional view illustrating the configuration of a plasma display panel according to the present invention.

As shown in FIG. 2, the plasma display panel of the present embodiment includes an upper substrate 200 and a lower substrate 200 arranged parallel to the upper substrate 200 by interposing barrier ribs 213.

A plurality of pairs of sustain electrodes 201 and 202, an upper dielectric layer 203 and a protective film 204 are formed on the upper substrate 200 in this sequence. Here, the sustain electrode 201 or 202 includes a transparent electrode a and bus electrode b. Also, address electrodes 211 for causing discharge with the pairs of sustain electrodes 201 and 202 and a lower dielectric layer 212 are formed on the lower substrate 210 in this sequence.

Phosphors 214 for generating visible rays having original colors are applied to side surfaces of the barrier ribs 213 over the lower dielectric layer 212.

The barrier ribs 213 of the present invention serve to divide a plurality of light emitting cells from one another. In the present invention, the side surfaces of the barrier ribs 213 facing the light emitting cells are formed unevenly.

Specifically, the side surfaces of each barrier rib 213 facing the light emitting cells have a plurality of convexities A formed at predetermined regions thereof, and at least one concavity B formed between the convexities A.

Here, a boundary C between the associated convexity A and concavity B may be formed perpendicular to the convexity A and concavity B, or may be inclined by a predetermined angle.

When the boundary C between the convexity A and the concavity B is inclined by a predetermined angle, the inclined boundary between the concavity B and the convexity A may have an acute or obtuse inclination angle.

The concavity B or convexity A may have a flat shape, round shape, horn shape, or the like.

Preferably, uppermost and lowermost portions of the side surfaces of each barrier rib 213 may have a convex shape.

This is because contact areas between the barrier rib 213 and the upper/lower substrates 200 and 210 have to be wide in order to support the upper and lower substrates 200 and 210 by use of the barrier rib 213.

The barrier rib 213 of the present invention having the uneven side surfaces includes a plurality of first layers 213a having a predetermined width, and at least one second layer 213b formed between the first layers 213a and having a width smaller than that of the first layers 213a.

Specifically, the barrier rib 213 of the present invention is configured such that the first and second layers 213a and 213b are alternately stacked one above another in sequence.

Here, the first and second layers 213a and 213b may be made of materials having different etching rates from each other. Preferably, the first layer 213a is made of a material having an etching rate lower than that of the second layer 213b.

Also, the first and second layers 213a and 213b may have different thicknesses from each other. Preferably, the first layer 213a has a thickness larger than that of the second layer 312b.

The boundary C between the first and second layers 213a and 213b may be formed perpendicular to side surfaces of the first and second layers 213a and 21b, or may be inclined, on the basis of the etching rates or other etching conditions of the first and second layers 213a and 213b.

The side surfaces A and B of the first and second layers 213a and 213b facing the light emitting cells may have a flat shape, round shape, horn shape, or the like.

The side surfaces A and B of the first and second layers 213a and 213b may be etched to have a variety of shapes, on the basis of the etching rates or other etching conditions thereof.

As shown in FIG. 2, in the present invention, the uppermost and lowermost portions of the barrier rib 213 are formed of the first layers 213a having a larger width than that of the second layer 213b. This configuration is efficient to increase the strength of the barrier rib 213 required to support the upper and lower substrates 200 and 210.

As stated above, as a result of forming the side surfaces of the barrier rib unevenly, the present invention has the effects of increasing a phosphor application area inside the light emitting cells and preventing phosphors of one light emitting cell from penetrating adjacent light emitting cells.

Now, a method of manufacturing the barrier ribs of the plasma display panel of the present invention having the above described configuration will be explained.

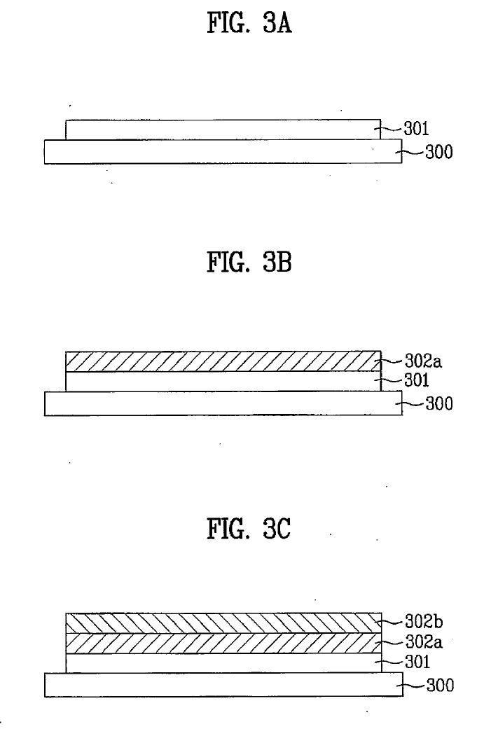

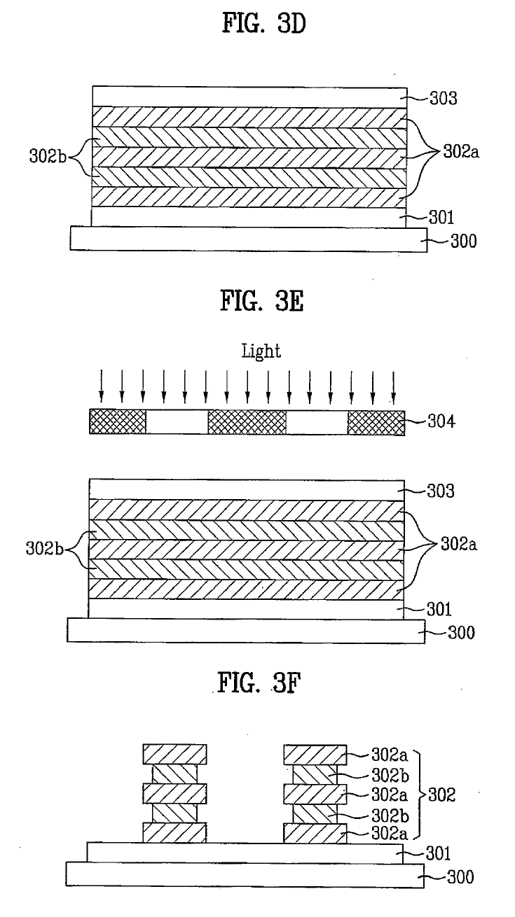

FIGS. 3A to 3F are sectional views illustrating a process for manufacturing the barrier ribs of the plasma display panel according to a first embodiment of the present invention.

Referring firstly to FIG. 3A, a lower dielectric layer 301 is formed on a lower substrate 300 that is made of glass, etc.

Referring secondly to FIG. 3B, a first barrier rib paste 302a is applied onto the lower dielectric layer 301 by use of a screen printing method.

Referring thirdly to FIG. 3C, a second barrier rib paste 302b is applied onto the first barrier rib paste 302a.

The first barrier rib paste 302a has a different etching rate from that of the second barrier rib paste 302b. Preferably, the etching rate of the first barrier rib paste 302a is lower than that of the second barrier rib paste 302b.

The above described processes of FIGS. 3B and 3C are repeated such that the first barrier rib paste 302a and second barrier rib paste 302b are alternately stacked one above another to obtain a predetermined height.

In this case, an uppermost portion of the barrier rib is formed by the first barrier rib paste 302a.

Referring fourthly to FIG. 3D, a dry film resist 303 is formed on the first barrier rib paste 302a. Thereafter, referring fifthly to FIG. 3E, a predetermined region of the dry film resist 303 is exposed to light and developed by use of a photo mask 304 having a predetermined pattern.

Referring sixthly to FIG. 3F, the first barrier rib paste 302a and second barrier rib paste 302b are etched by use of the dry film resist 303 as an etching mask, to form barrier ribs

In this case, side surfaces of the barrier ribs 302 are formed unevenly to have a “convex and concave” shape.

This is because the first barrier rib paste 302a and second barrier rib paste 302b have different etching rates from each other.

Specifically, the first barrier rib paste 302a has an etching rate lower than that of the second barrier rib paste 302b. Therefore, the first barrier rib paste 302a is etched less than the second barrier rib paste 302b.

Accordingly, the side surfaces of the barrier ribs 302 facing the light emitting cells are formed with convexities and concavities.

To obtain the first barrier rib paste 302a and second barrier rib paste 302b having different etching rates from each other, the structure of glass having a low melting point or a composition ratio of the glass to filler may be changed.

Although the first embodiment of the present invention employs a screen printing method to form the barrier ribs of the plasma display panel, the barrier ribs may be formed by use of a laminating method for laminating a green sheet.

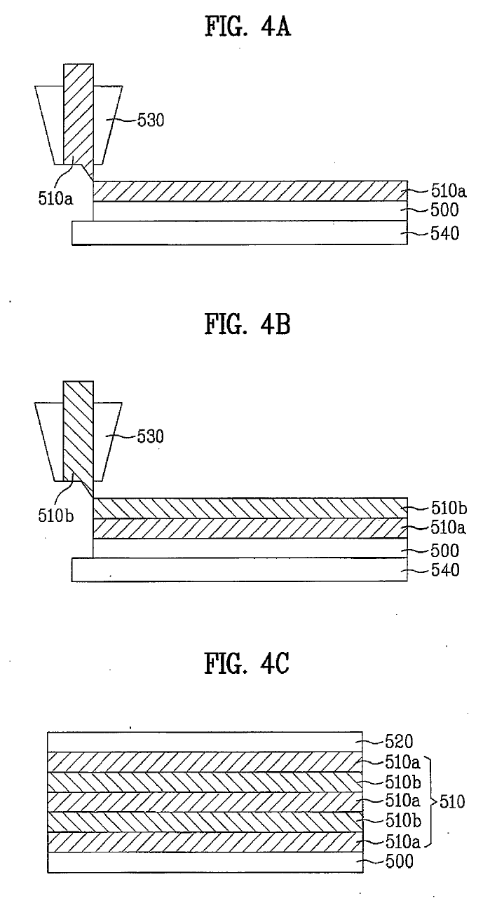

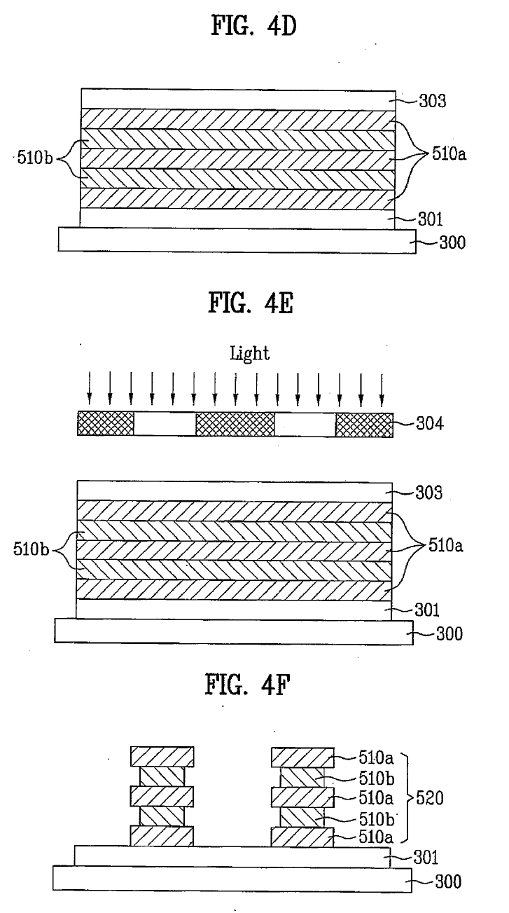

FIGS. 4A to 4F are sectional views illustrating a process for manufacturing the barrier ribs of the plasma display panel according to a second embodiment of the present invention.

Referring firstly to FIG. 4A, a first slurry 510a for forming a barrier rib is discharged from a coater 530, and is applied onto a base film 500 by a predetermined thickness. Here, the base film 500 is formed on a conveyor belt 540.

Referring secondly to FIG. 4B, the first barrier rib slurry 510a applied onto the base film 500 is dried to form a first dry film. Thereafter, a second barrier rib slurry 510b is applied onto the first dry film, to form a second dry film.

In this case, the first barrier rib slurry 510a and second barrier rib slurry 510b are prepared to have different etching rates from each other by changing properties of glass and filler constituting the barrier rib slurry, more particularly, the structure of the glass having a low melting point and the composition ratio of the glass to the filler.

The processes of FIGS. 4A and 4B are repeated until a dry film 510 having a predetermined height is formed.

Referring thirdly to FIG. 4C, a cover film 520 is covered over the resulting dry film 510 to complete a barrier rib green sheet.

Referring fourthly to FIG. 4D, the barrier rib green sheet is laminated on the lower dielectric layer 301, and then, the dry film resist 303 is formed on the first barrier rib slurry 510a of the barrier rib green sheet.

Referring fifthly to FIG. 4E, a predetermined region of the dry film resist 303 is exposed to light and developed by use of the photo mask 304 having a predetermined pattern.

Referring sixthly to FIG. 4F, the first barrier rib slurry 510a and second barrier rib slurry 510b are etched by use of the dry film resist 303 as an etching mask, to form barrier ribs 520.

In this case, side surfaces of the barrier ribs 520 are formed unevenly to have a “convex and concave” shape.

When the barrier ribs are formed by use of a green sheet as described in the second embodiment of the present invention, uniform control of the barrier rib layer can be achieved. Accordingly, there is an advantage in that uniformity of the plasma display panel can be achieved.

As apparent from the above description, the plasma display panel of the present invention is configured such that side surfaces of barrier ribs facing light emitting cells are formed to have a “convex and concave” shape. This has the effect of preventing color mixture of phosphors between adjacent light emitting cells, and increasing a phosphor application area, resulting in improvement in the brightness and discharge efficiency of the plasma display panel.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel having barrier ribs dividing a plurality of light emitting cells from one another, comprising:
a plurality of convexities formed on side surfaces of the barrier ribs facing the light emitting cells at predetermined regions of the side surfaces; and
at least one concavity formed between the convexities.

2. The panel according to claim 1, wherein a boundary between the associated concavity and convexity is formed perpendicular to the concavity and convexity.

3. The panel according to claim 1, wherein a boundary between the associated concavity and convexity is inclined.

4. The panel according to claim 3, wherein the inclined boundary between the convexity and concavity has an acute or obtuse inclination angle.

5. The panel according to claim 1, wherein each convexity or concavity has a shape selected from among a flat shape, round shape and horn shape.

6. The panel according to claim 1, wherein uppermost and lowermost portions of the side surfaces of the barrier ribs have a convex shape.

7. A plasma display panel having barrier ribs dividing a plurality of light emitting cells from one another, wherein
each barrier rib includes:
a plurality of first layers having a predetermined width; and
at least one second layer formed between the first layers and having a width smaller than that of the first layers.

8. The panel according to claim 7, wherein the first and second layers are made of materials having different etching rates from each other.

9. The panel according to claim 7, wherein the first layer is made of a material having an etching rate lower than that of the second layer.

10. The panel according to claim 7, wherein the first and second layers have different thicknesses from each other.

11. The panel according to claim 7, wherein the first layer has a thickness larger than that of the second layer.

12. The panel according to claim 7, wherein a boundary between the first and second layers is formed perpendicular to side surfaces of the first and second layers, or inclined relative to the side surfaces.

13. The panel according to claim 7, wherein side surfaces of the first and second layers facing the light emitting cells have a shape selected from among a flat shape, round shape and horn shape.

14. The panel according to claim 7, wherein uppermost and lowermost layers of the barrier ribs are formed of the first layers having a width larger than that of the second layer.

15. A method of manufacturing barrier ribs of a plasma display panel for dividing a plurality of light emitting cells from one another, comprising:
forming a dielectric layer on a substrate having electrodes;
forming a barrier rib paste having a predetermined height by alternately stacking a first paste and second paste on the dielectric layer, the first paste and second paste having different etching rates from each other; and
forming the barrier ribs having convexities and concavities at side surfaces thereof by etching predetermined regions of the barrier rib paste.

16. The method according to claim 15, wherein the formation of the barrier ribs having convexities and concavities at side surfaces thereof comprises:
forming a dry film resist on the barrier rib paste;
exposing and developing predetermined regions of the dry film resist;
forming the barrier ribs to have the convexities and concavities at the side surfaces thereof by etching the barrier rib paste by use of the dry film resist as an etching mask; and
removing the residual dry film resist.

17. The method according to claim 15, wherein the barrier rib paste is formed via a screen printing method.

18. A method of manufacturing barrier ribs of a plasma display panel for dividing a plurality of light emitting cells from one another, comprising:
forming a dielectric layer on a substrate having electrodes;
forming a barrier rib green sheet having a predetermined height by alternately stacking a first dry film and second dry film on the dielectric layer, the first dry film and second dry film having different etching rates from each other; and
forming the barrier ribs having convexities and concavities at side surfaces thereof by etching predetermined regions of the barrier rib green sheet.

19. The method according to claim 18, wherein the formation of the barrier ribs having convexities and concavities at side surfaces thereof comprises:
forming a dry film resist on the barrier rib green sheet;
exposing and developing predetermined regions of the dry film resist;
forming the barrier ribs to have the convexities and concavities at the side surfaces thereof by etching the barrier rib green sheet by use of the dry film resist as an etching mask; and
removing the residual dry film resist.

20. The method according to claim 18, wherein the barrier rib green sheet is formed via a laminating method.
